(19) United States
(12) Patent Application Publication
(10) Pub. No.: US 2026/0257414 A1
(43) Pub. Date: Sep. 3, 2026

(54) FILTER ASSEMBLY

(71) Applicant: Maag Germany GmbH, Grossostheim (DE)

(72) Inventor: Wilfried Leuders, Gronau (DE)

(73) Assignee: Maag Germany GmbH, Grossostheim (DE)

(21) Appl. No.: 18/867,071

(22) PCT Filed: May 2, 2023
(86) PCT No.: PCT/EP2023/061568

§ 371 Date: Nov. 19, 2024

(30) Foreign Application Priority Data
May 19, 2022 (DE) 10 2022 112 549.1

(51) Int. Cl. B29C 48/691; B29C 48/27; B29C 48/694

(52) U.S. Cl. CPC B29C 48/6912; B29C 48/2735; B29C 48/694

(57) ABSTRACT

The invention relates to a filter assembly (10) for a fluid to be filtered, comprising a filter housing (12). First openings (36a) of through-channels (36) of a filter support wall (30, 32) and the dimensions of a cleaning piston (66) are matched together such that the total surface area of first openings (36a) extending into a receiving recess (68, 70) and regions of first openings (36a) adds up to a value F₁, said value F₁ being the same over a movement path of the cleaning piston (66) across the region of the first openings (36a) of the through-channels (36) of the filter support wall (30, 32).

This patent application is the national phase entry of PCT/EP2023/061568, international application filing date May 2, 2023, which claims the benefit and priority of and to German patent application no. 10 2022 112 549.1, filed May 19, 2022.

PCT/EP2023/061568, international application filing date May 2, 2023 and German patent application no. 10 2022 112 549.1, filed May 19, 2022 are incorporated herein by reference hereto in their entire-ties.

### BACKGROUND OF THE INVENTION

The invention relates to a filter assembly and to a method for filtering fluid using a filter assembly.

Filter assemblies of this type are used in plastics processing. In plastics processing systems, plastic granulate, regrind or powdery components are often heated to a liquid state and then processed. It is not uncommon for the plastic granulate to be made from recycled material, which often also contains impurities in the form of foreign particles. An example of the plastic processing systems used for this purpose are extruders. Extruders are conveying devices that operate in the manner of a screw conveyor to press solid to viscous masses evenly out of a shaping aperture under high pressure and high temperature, for example in order to produce products such as flat films or blown films in an extrusion process. Other systems also use gear pumps for this purpose, for example.

Even when pure raw materials are used, the heated and viscous plastic usually does contain some dirt particles. These dirt particles must be kept out of both the plastics processing systems and the end product. Appropriate filters are used to filter these dirt particles out of the liquid plastic. The liquid plastic is passed through the filter assembly under pressure before the raw material is processed further in the plastics processing system.

In order to achieve a uniform processing process, the processing pressure must be as constant as possible. The screen filters in the filter assemblies must therefore be replaced or cleaned regularly in order to ensure an even discharge and thus a constant processing pressure.

For this purpose, various changing devices are used for the screens that constitute the filters. The screen changing systems currently in use include piston screen changers, screen wheel filters, belt screen changers, rotary screen changers and flat slide valves. The screen changing systems usually operate automatically and are driven mechanically or hydraulically. However, manual screen changing systems are also in use.

A generic filter assembly for a fluid to be filtered is known from DE 20 2017 007 054 U1. The filter assembly is provided with a filter housing which contains an inlet opening for an inlet duct and an outlet opening for an outlet duct. A flow body, which may be part of a piston for extending out of the filter housing for a filter change of the filter assembly, together with a filter screen and a filter screen stop wall separates a first chamber from a second chamber in the filter housing. The flow body has a filter support wall with a first side and a second side that is remote from the first side, with this second side resting against the filter screen at least in some areas and holding the filter screen against the stop wall. The first chamber is connected to the inlet duct, and the second chamber is connected to the outlet duct. In the filter support wall, through-channels with associated openings are provided on each side of the filter support wall, through which the fluid is made to flow out of the first chamber via the first opening through the through-channel to the second opening for filtering to the filter screen. Through-channels with openings on each side of the stop wall are also provided in the stop wall, through which the filtered fluid is fed from the filter screen into the second chamber.

In addition, a movable cleaning piston is provided, which rests against the first side of the filter support wall with a guide area thereof. The cleaning piston has at least one receiving recess arranged within the guide area, with part of the first openings of the filter support wall extending into this receiving recess. Furthermore, the cleaning piston is provided with a discharge duct for discharging the backwashed fluid, so that by moving the cleaning piston along the filter support wall, any deposits on the filter screen and on the filter support wall are removed by backwashing part of the filtered fluid from the second chamber through the stop wall, the filter screen, the filter support wall via the second opening, the through-channel of the filter support wall, the first opening and the receiving recess of the cleaning piston into the discharge duct of the cleaning piston.

For cleaning the filter screen and thus backwashing the filter screen, the cleaning piston is moved successively from a rest position thereof outside the area having the openings of the through-channels of the filter support wall into the area of the openings of the through-channels of the filter support wall. The cleaning piston moves over the entire area of the openings of the through-channels of the filter support wall to an opposite rest position, or is then moved back to the rest position from which the cleaning piston started.

However, the problem with this prior art design is that the backwashing process will result in pressure fluctuations in the entire system, as the volume of the filtered fluid emerging from the filter assembly will be changed as a result of the initial backwashing step and/or the subsequent backwashing step of the individual backwashing partial surfaces. In particular, these pressure fluctuations have a negative effect in the area of the tools, such as nozzles, for example in film production or in pelletizing processes. In film production, the material may ultimately tear when the pressure is too low. However, as with all other extrusion processes, quality defects may also occur in the form of varying layer and wall thicknesses or pellet sizes, but this is to be avoided.

### SUMMARY OF THE INVENTION

For this reason, it is the object of the invention to improve on a filter assembly in such a way that constant pressure conditions are created upstream and downstream of the filter whilst avoiding the disadvantages mentioned above, with effective backwashing being achieved at the same time, thereby increasing the quality of the process and the service life of the filter assembly.

This object is accomplished in a first aspect of the invention by the characterizing features of claim 1 in conjunction with the features of its preamble.

The dependent claims relate to advantageous further embodiments of the invention.

The invention is based on the realization that coordinating the receiving recess of the cleaning piston with the first openings of the filter support wall in such a way that the sum of the cross-sectional area of the first openings, which projects into the receiving recess of the cleaning piston, is the same over the entire travel path of the cleaning piston along the filter support wall, will allow the pressure during backwashing to be kept constant regardless of the travel position of the cleaning piston. This means that the quality level of the products can at least be kept constant. Moreover, this improves the service life of the filter assembly.

Furthermore, pressure fluctuations can be avoided by permanent backwashing, as the pressure fluctuations in the outlet duct caused by the cleaning piston moving into the area of the openings in the filter support wall are avoided. The quality of the products is thus further increased with this filter assembly.

According to the invention, the first openings of the filter support wall and the dimensions of the cleaning piston are therefore matched to one another in such a way that the total area of the openings and regions of openings extending into the receiving recess produces a value F₁, which value F₁ is always the same over a travel path of the cleaning piston across the region of the first openings of the through-channels of the filter support wall. The sum of the cross-sectional areas of the openings of the filter support wall projecting into the receiving recess of the cleaning piston is thus always the same, regardless of the travel position of the cleaning piston, so that the pressure fluctuations previously occurring when moving the cleaning piston, for example from a row of first openings of the filter support wall to the next row of first openings and, above all, when moving the piston from the rest position into the region of the first openings of the filter support wall, can be easily avoided. This results in permanent backwashing, which increases the service life until it is time to change the filter.

In an advantageous further development of the invention, the cleaning piston has a first and a second end position. The travel path of the cleaning piston is between the first and second end positions. The value F₁ always remains the same both in the two end positions and over the entire travel path.

In principle, it is conceivable to use rotating cleaning pistons. However, it is preferred for the travel path of the cleaning piston relative to the filter support wall to be linear, in particular exclusively linear.

In particular, several rows of first openings of the through-channels of the filter support wall can be provided in the direction of travel starting from an end position of the cleaning piston. The centers of a series of first openings lie in a plane perpendicular to the travel path of the cleaning piston. The cross-sectional area of a row has the value F₂. Here, F₁=K×F₂, where K>0.

In this context, it has proven advantageous for adjacent rows of first openings to be arranged offset to one another, in particular perpendicular to an axis of the cleaning piston, for example axially offset to the longitudinal axis and/or offset at an angle to the longitudinal axis.

In order to keep the design and therefore also the manufacture as simple as possible, the value F₂ of the sum of the cross-sectional areas of a row of first openings corresponds to the value F₁.

At least the cross-sectional area of each first opening and the cross-sectional area of the adjoining through-channel may each have the same design, in particular also in their outer circumferential shape. For example, each first opening and the adjoining through-channel can have a circular cross-section with a diameter D and a radius R. Alternatively, each first opening and the adjoining through channel can also have other cross-sections, e.g. of a hexagonal or an oval shape.

In one embodiment of the invention, the distance of the receiving recess of the cleaning piston in a direction of travel of the cleaning piston is such that it is equal to or greater than the diameter D of the first opening. This makes it easy to keep the cleaning piston compact in size,

The rows of first openings can be arranged in such a way that, in a travel position of the cleaning piston and with K=1 and thus F₁=F₂, the first edge of the receiving recess of the cleaning piston is aligned with the edge of first openings of a row, and these openings are completely located in the receiving recess, and the second edge of the receiving recess is aligned with the edge of first openings of an adjacent row, the openings of which are not currently located in the receiving recess.

The filter assembly is therefore particularly suitable for applications that have high quality requirements, preferably for integration into a film production system.

In principle, the cleaning piston can be adapted to the shape of the filter support wall. Preferably, the area of the diffuser body assigned to the cleaning piston, and thus the cleaning piston, is rotationally symmetrical. The filter support wall is adapted to the cleaning piston, and the filter screen and the stop wall are adapted to the shape of the filter support wall. This makes it easy to manufacture the cleaning piston and the flow body.

In one embodiment of the invention, the filter support wall, the filter screen and the stop wall extend only over a partial circumference of the cleaning piston in the circumferential direction.

The receiving recess of the cleaning piston can comprise at least this partial circumference; in particular, the receiving recess of the cleaning piston extends at least over this partial circumference in the circumferential direction.

Preferably, the receiving recess of the cleaning piston is either designed as a groove with channels to the discharge ducts, or it extends radially inwards to the discharge duct like a cylindrical segment, depending on which is more favorable with regard to the specified dimensions for discharging the backwashed fluid.

The filter screen and the stop wall can be divided into two parts, in particular designed as two identical components.

The filter support wall also has at least two areas assigned to the filter screen and the filter support wall, in which the through-channels with the openings are provided.

Lastly, at least two receiving recesses can also be provided in the cleaning piston, which are assigned to the areas with the first openings and through-channels of the filter support wall.

In one embodiment of the invention, each component of the stop wall is designed as a cylindrical segment. The latter only extends over a partial angle in the circumferential direction. It also has outer walls that extend radially outwards away from the filter screen and laterally surround the area with the openings. The area with the radially outer openings of the stop wall is offset radially inwards in relation to the free end areas of the outer walls, i.e. the radially outward-facing end faces.

In order to ensure a secure arrangement of the stop wall and thus the filter screen in the flow body, the flow body surrounds the outer walls at least in some areas, in particular completely, right up to the end faces.

The flow body with the filter screen and the stop wall as well as the cleaning piston arranged inside the flow body can be part of a piston that can be extended from the filter housing for changing the filter screens. In any case, the individual components of the support wall and the individual components of the filter screen are then arranged in the flow body in a detachable manner.

The through-passages of the filter support wall preferably extend radially in relation to a concentric axis of the cleaning piston; in particular, these through-passages of the filter support wall are aligned with associated through-passages provided in the stop wall. In this case, these can also run radially outwards.

In another aspect, the invention is based on the realization that permanent backwashing, in particular with a permanently constant quantity of backwashed fluid, can increase both the quality of the end product and the service life of the filter assembly.

In accordance with this aspect of the invention, therefore, a method is provided for filtering fluid using a filter assembly, in particular of the type of filter assembly just described, in which permanent backwashing of the filtered fluid takes place in the filter assembly.

Preferably, the amount of backwashed fluid in the filter assembly always remains the same.

In particular, low-viscosity fluids, preferably of a viscosity in a range of between 50 Pas and 5,000 Pas, are filtered for the operation of the filter assembly.

With regard to the service life of the filter assembly, it is advantageous if the cleaning piston is permanently moved back and forth from the first end position to the second end position.

The cleaning piston can be moved at a speed which is in a range of between 10% and 200% of the discharge speed of the filtered fluid/the input speed of the fluid to be filtered, in particular in a range of between 45% and 150%.

Preferably, the amount of backwashed fluid is in a range of between 0.1% and 2.0% of the fluid introduced into the filter assembly, in particular in a range of between 0.5% and 1.0%.

The filter support wall is preferably provided with an inner sleeve and a basic filter support wall. The inner sleeve comprises the first and second openings and the through-passages. This allows different requirements to be met with regard to the material or structure of the inner sleeve and the basic filter support wall. The parts can therefore be optimized with regard to their use and the resulting loads on the material. This also simplifies the manufacturing process.

In another advantageous embodiment of the invention, the inner sleeve is detachably connected to the basic filter support wall. This allows the openings and through-channels to be optimized and adapted theologically and in terms of flow technology with regard to the viscosity of the medium to be processed. Furthermore, the inner sleeve can be replaced in the event of wear, for example abrasive wear due to the permanent movement of the backwash piston, in order to ensure reliable filtering over a longer filtering period.

Preferably, the cross-sectional areas of the openings and the through-channels each have a height and a width. The height is multiple times greater than the width. This ensures that the dimensions of the cleaning piston are reduced in the longitudinal direction.

Preferably, the cross-sectional area of the openings corresponds to 65% of the cross-sectional area of the receiving recesses. This reduces the pressure on the inlet side of the filter support wall and increases the effective filter area.

In another advantageous embodiment of the invention, the shape of each opening corresponds to the shape of the associated receiving recess. This allows a reduction of the pressure on the inlet side of the filter support wall. In addition, this optimizes the flow conditions for the fluid to be filtered.

Additional advantages, features and possible applications of the present invention will be apparent from the description which follows, in which reference is made to the embodiments illustrated in the drawings.

Throughout the description, the claims and the drawings, those terms and associated reference signs are used as are stated in the list of reference signs below.

### BRIEF DESCRIPTION OF THE DRAWINGS

In the drawings,

FIG. 1 is a perspective view, taken at an angle from above, of a first side of a piston screen changer-type filter assembly with its piston extended, according to a first embodiment of the invention;

FIG. 2 is a perspective view, taken at an angle from above, of a second side of the filter assembly of FIG. 1;

FIG. 3 is a perspective view of a first side of the filter assembly of FIG. 1, with its piston retracted;

FIG. 4 is a view of a first longitudinal section through the filter assembly of FIG. 3;

FIG. 5 is a view of a second longitudinal section through the filter assembly of FIG. 3, offset by 90° around the longitudinal axis with respect to the first longitudinal section;

FIG. 6a is a view of a cross-section through the filter assembly in the cleaning piston of FIG. 3, with a first type of cleaning piston;

FIG. 6b is a view of a cross-section through the filter assembly in the cleaning piston of FIG. 3, with a second type of cleaning piston;

FIG. 7 is a perspective view of FIG. 1, but with the stop walls shown exploded away;

FIG. 8 is a perspective view of the piston of the filter assembly without the stop wall and the filter screen, so that the filter support wall can be seen;

FIG. 9 is a perspective view of a partially retracted piston of the filter assembly of FIG. 1 as seen from the first side thereof, after the screen change;

FIG. 10 is a longitudinal sectional view through the filter assembly of FIG. 4 with a two-part filter support wall;

FIG. 11 is a perspective view of the piston of the filter assembly with its stop wall detached and slot-shaped through-holes, and

FIG. 12 is a perspective view of the inner sleeve of the filter assembly with end stop.

### DESCRIPTION OF THE INVENTION

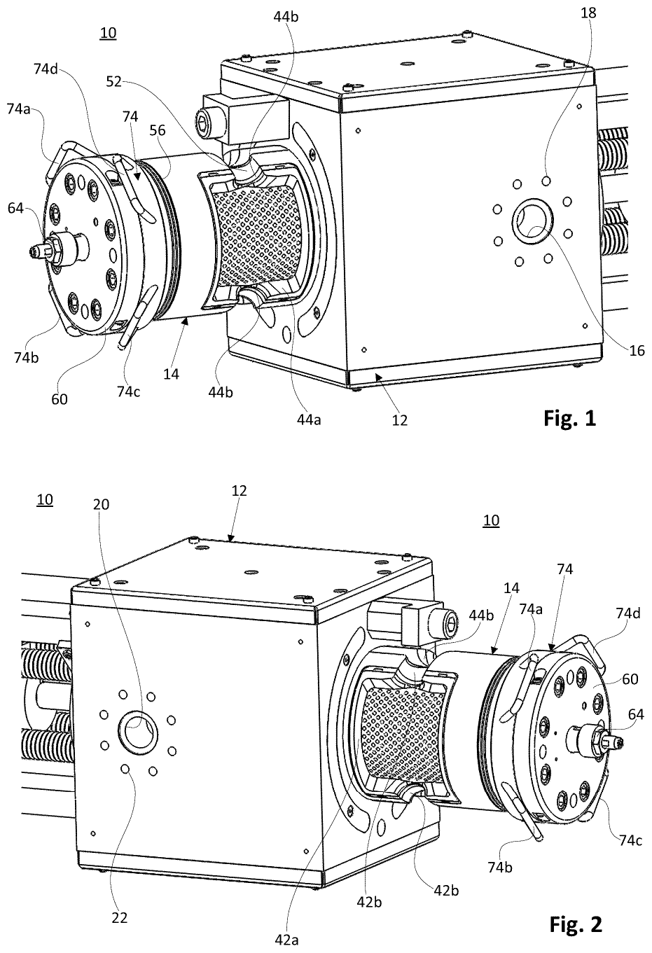

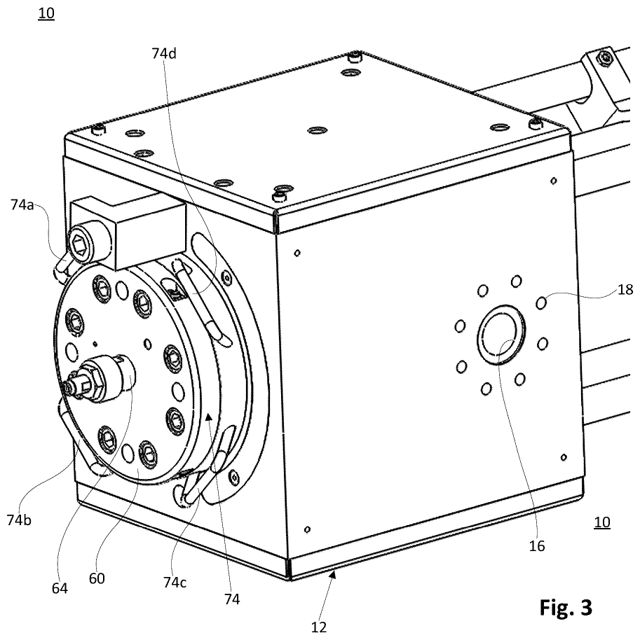

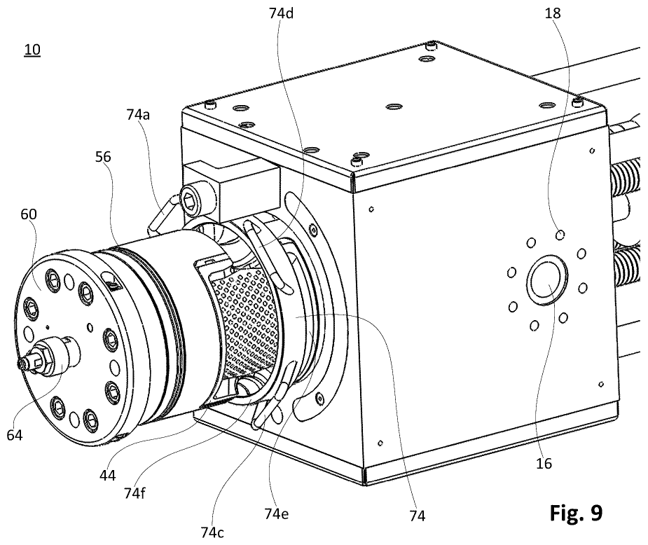

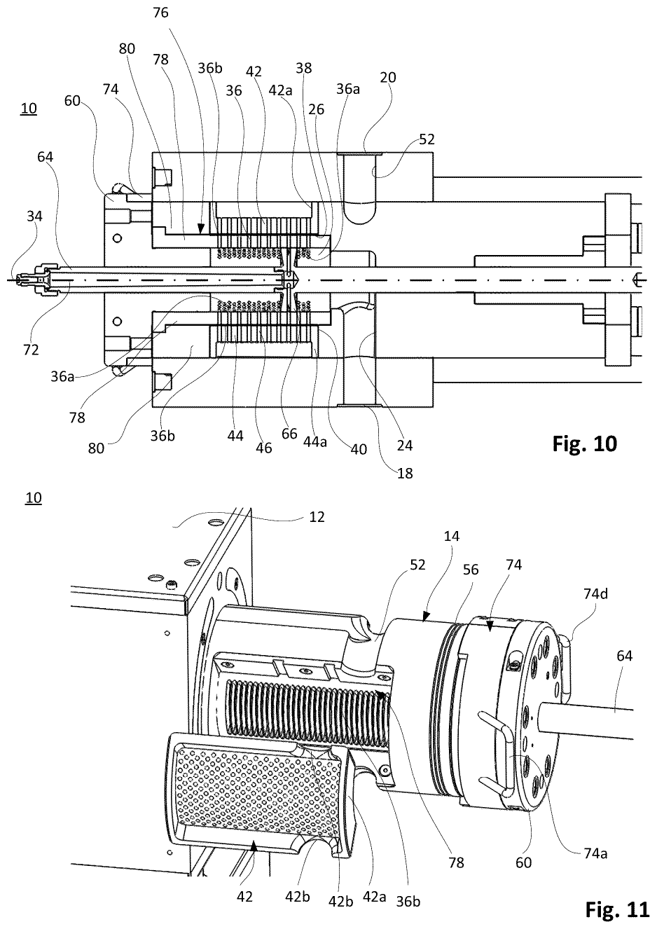

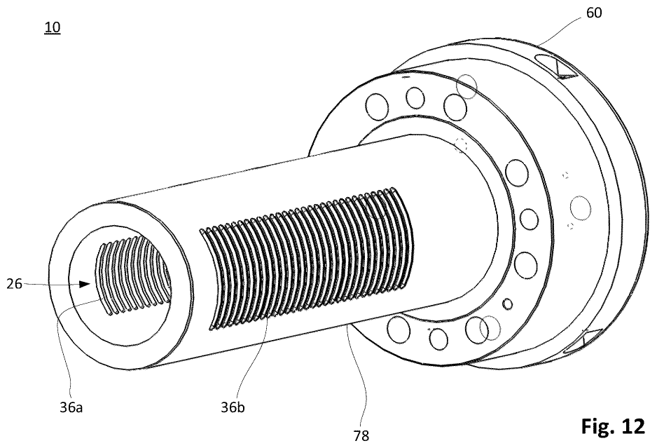

Illustrated in FIGS. 1 to 10 is a filter assembly 10 according to the invention including a piston screen changer. FIG. 10 shows one variant, and FIGS. 11 and 12 show another variant of the filter assembly 10 according to the invention. The filter assembly 10 comprises a housing 12 in which a piston 14 can be moved as required between a screen-changing position and a filter position thereof. In the screen-changing position, a filter screen can be changed. In the filter position, a fluid can flow through the filter assembly 10 and can be filtered. In FIGS. 1, 2 and 7, the piston 14 is seen in the screen-changing position in which it is extended relative to the housing 12, and in FIGS. 3, 4, 5, 6a and 6b the piston 14 is seen in the filter position in which it is retracted relative to the housing 12.

An inlet opening 16 is provided laterally on a first side of the housing 12, via which fluids having a low viscosity, preferably in a range of between 50 Pas and 5,000 Pas, for example plastic fluids, are fed to the filter assembly 10, flow through it and are filtered in the process, as will be explained in detail below. The fluid is supplied to the housing 12 through the inlet opening 16 via a feed line (not shown here). The feed line can be screwed to the housing 12 using a flange connection. For this purpose, the housing 12 has corresponding threaded holes 18, see for example FIGS. 1 and 3. Screws engage in these threaded holes 18 and in corresponding holes in a flange of the feed line, which screws are used to fasten the flange with the feed line to the housing 12.

Accordingly, an outlet opening 20 is provided on a second side of the housing 12 remote from the first side, via which the filtered fluid is transported away from the filter assembly 10 for further processing via a discharge line (not shown here). The discharge line can also be screwed to the housing 12 using a flange connection. For this purpose, the housing 12 has corresponding threaded holes 22, see for example FIG. 2. Screws engage in these threaded holes 22 and in corresponding holes in a flange of the discharge line, which screws are used to fasten the flange with the discharge line to the housing 12.

For example, the filter assembly 10 can be an integral part of a system for film production or granulation. In this case, the filtered plastic fluid is fed via the discharge line to a nozzle for discharging the filtered plastic fluid and transforming it into a film which is then to be discharged from the nozzle.

The drive of the piston 14 in the housing 12 for moving the piston between the screen-changing position and the filter position is basically known, so that this will not be discussed further here.

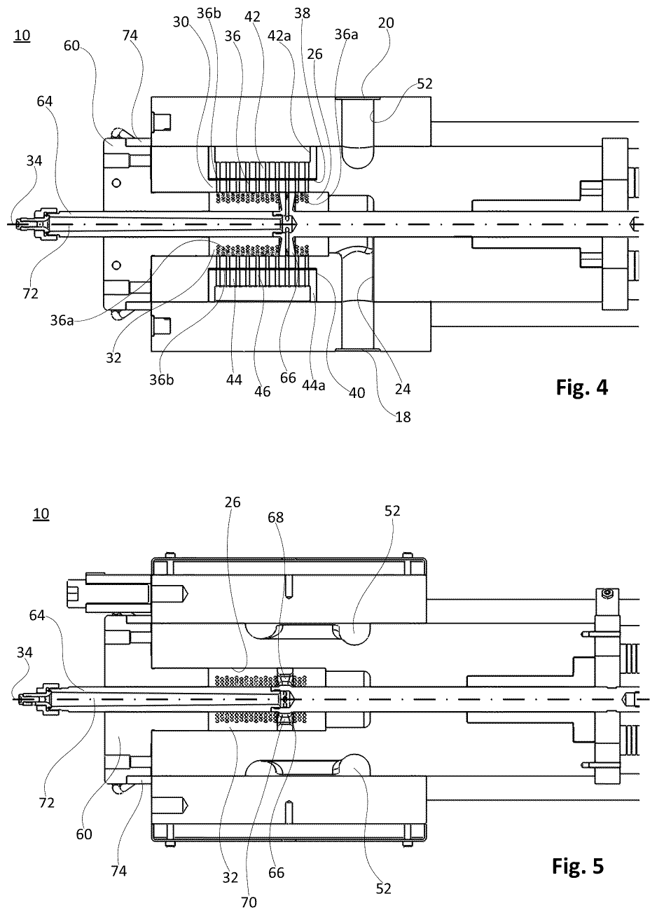

As is seen in FIGS. 4 and 5 in particular, the inlet opening 16 is connected to a cylindrical interior 26 in the piston 14 via an inlet line 24 running inside the housing 12 and the piston 14. The interior 26 is bounded radially outwards in the circumferential direction by the inner walls 28 of the piston 14 and by two filter support walls 30 and 32 in the form of cylindrical segments. The filter support walls 30, 32 each span an angle of approx. 120°. The closed inner walls 28 of the piston 14 also extend at an angle of 120° between the filter support walls 30 and 32.

Through-holes 36 arranged radially with respect to a longitudinal axis 34 of the piston 14 are provided in each filter support wall 30, 32. The through-holes 36 each have the same bore cross-section with a uniform diameter D and thus a uniform radius R with an inner inlet opening 36a and an outer outlet opening 36b. The inlet opening 36a, the outlet opening 36b and the through-hole 36 thus have the same radius. Several center points of inlet openings 36a of the through-holes 36 lie in one plane and thus form a row of inlet openings 36a arranged next to each other in the circumferential direction. A further row of inlet openings 36a is provided offset in the longitudinal direction and in the circumferential direction, the centers of which also lie in one plane. The planes of the centers of the rows run parallel to each other. Further rows of inlet openings 36a of the through-holes 36 follow, each arranged offset in relation to the respective preceding row, so that the inner surface of the filter support wall 30 is formed almost entirely by rows of inlet openings 36a of the through-holes 36.

In an alternative embodiment (not shown), the through-holes 36, the inlet openings 36a and the outlet openings 36b are provided in the shape of slots in a radial direction relative to the longitudinal axis 34. The height is multiple times greater than the width. The cross-sectional area of the through-holes 36 corresponds to 75% of the cross-sectional area of the receiving recess 68, 70 of the cleaning piston 66. The shape of the through-holes 36 corresponds to the shape of the receiving recess 68, 70 of the cleaning piston 66.

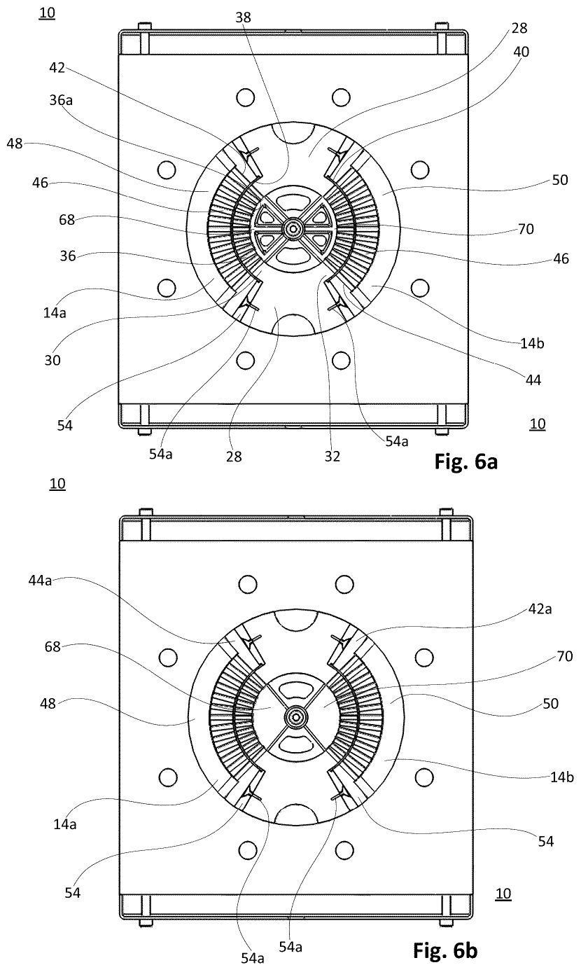

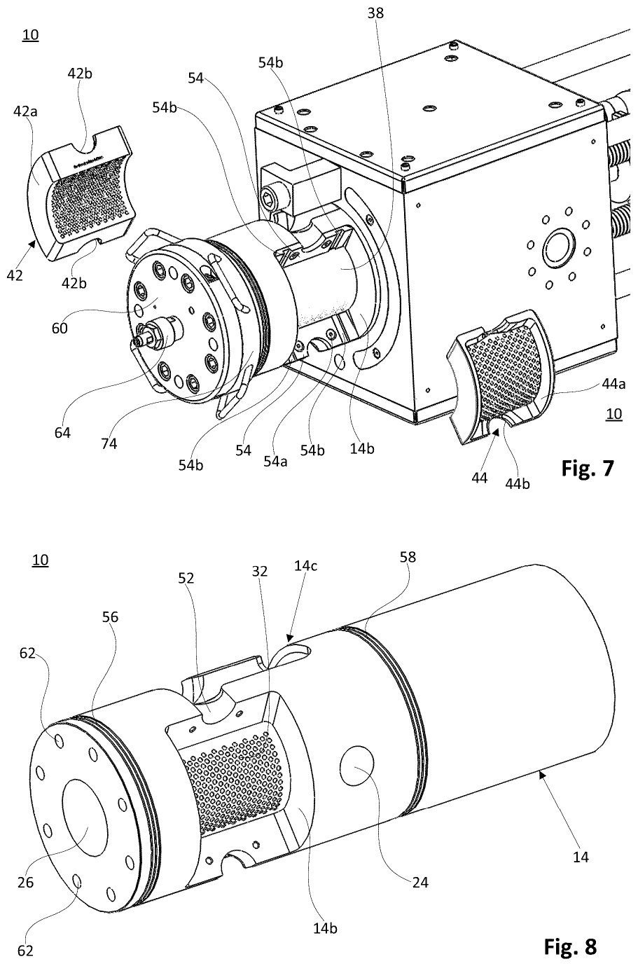

Each filter support wall 30, 32 is formed in one piece with, and of the same material as, the piston 14 and holds a filter screen 38, 40, see FIGS. 6a, 6b, 7, which can be removed from the piston 14, against a stop wall 42, 44, which can also be removed from the piston. The stop wall 42, 44 also has through-holes 46 which are radially aligned with respect to the longitudinal axis 34 of the piston 14, which are aligned with respect to the through-holes 36 of the filter support wall 30, in particular are flush with them.

The stop wall 42, 44 is set back from the outer circumferential surface of the piston 14 and forms an outlet chamber 48, 50 for the filtered fluid. The stop wall 42 has side walls 42a laterally delimiting this outlet chamber 48, which stop walls 42a completely laterally surrounds the surface with the through-holes 46 of the stop wall 42. Accordingly, the stop wall 44 has side walls 44a laterally delimiting the outlet chamber 50, which completely laterally surrounds the surface with the through-holes 46 of the stop wall 44. The side walls 42a, 44a are aligned with the outer circumferential surface of the piston 14 when correctly mounted. The piston 14 completely surrounds the side walls 42a, 44a on the sides. A clamp connection is used to hold the stop walls 42, 44 in place in the piston 14. The outlet chamber 48, 50 is connected to a discharge line 52. For this purpose, the side walls 42a, 44a each have semicircular recesses 42b, 44b on the outside, which are aligned with the discharge line 52 on the outside of the piston, which discharge line 52 is designed as a semicircular recess.

From the outlet chamber 48, 50, the discharge line 52 initially extends transversely to the longitudinal axis 34 of the piston 14 on its outer side, then along the longitudinal axis 34 of the piston 14, and again transversely to the longitudinal axis 34 of the piston 14, and then merges into a tubular region of the housing 12 from where it runs to the outlet opening 20 of the filter assembly 10. Within the piston, the discharge line 52 is U-shaped/semi-circular in cross-section and runs on the outside of the piston 14 and is bounded on the side opposite the discharge line 52 by a cylindrical inner side of the housing 12. Two opposite sides of receiving areas 14a, 14b for the stop walls 42, 44 of the piston 14 are each provided with a plate 54, which plates are screwed to the piston 14 by means of screws 54a. The plate 54 has two grooves 54b each which serve to facilitate removing the stop walls 42, 44 and then the filter screen 38, 40 from the piston 14. The grooves 54b run radially in relation to the longitudinal axis 34 of the piston 14 or to an axis parallel to the longitudinal axis 34.

Seals 56 are provided at the free end of the piston 14, see FIG. 8. In addition, further seals 58 are provided in the longitudinal direction downstream of the feed line 24 and the discharge line 52 in the piston 14. The flow body 14c of the piston 14 is located between the seals 56, 58. In operation, the seals 56, 58 seal of the flow area of the fluid through the piston 14, i.e. through the flow body 14c, and thus through the filter assembly 10 in the housing 12, in the filter position.

An end stop 60 is screwed onto the end face of the piston 14 at the free end of the piston 14 that protrudes from the housing 12 in the filter position. Corresponding threaded holes 62 are provided in the piston 14 for this purpose. In addition, the end stop 60 is used to guide a piston rod 64 for a cleaning piston 66 that can be moved in the interior 26. The cleaning piston 66 is located in the interior 26 and rests against the filter support walls 30, 32 and the inner walls 28 of the piston 14. The cleaning piston 66 is cylindrical and adapted to the inner contour of the piston 14 formed by the filter support walls 30, 32 and inner walls 28. The piston rod 64 is firmly connected to the cleaning piston 66 and extends on the side remote from the end stop 60 to a drive for the cleaning piston 66, which drive is not shown in detail here. During operation of the filter assembly, the cleaning piston 66 is continuously moved back and forth by the drive between a first end position and a second end position. The end stop 60 also limits the interior 26 in a longitudinal direction.

The cleaning piston 66 is provided with two identically designed receiving recesses 68, 70 arranged on the circumferential surface and assigned to the filter support walls 30, 32. Receiving recess 68 is associated with filter support wall 30 and receiving recess 70 is associated with filter support wall 32, and they extend in the circumferential direction of the interior 26 in line with the rows of inlet openings 36a of the filter support walls 30. The receiving recesses 68, 70 are connected to a discharge duct 72 arranged concentrically in the cleaning piston 66 for discharging backflushed fluid. Using the drive (not shown here), the cleaning piston 66 is continuously moved linearly from a starting position at the edge of the filter support walls 30, 32 to an end position at the remote edge of the filter support walls 30, 32 and back during operation of the filter assembly 10. The direction of the travel path is parallel to the longitudinal axis 34 of the piston 14.

The successive movement of the cleaning piston 66 along the filter support walls 30, 32 causes backwashed fluid, and thus deposits from the stop walls 42, 44, to be transferred from the filter screens 38, 40 and from the filter support walls 30, 32 into the discharge duct 72 of the cleaning piston 66. The filtered fluid flows out of the outlet chambers 48, 50 through the stop walls 42, 44, the filter screens 38, 40 and the filter support walls 30, 32 and back into the receiving recesses 68, 70 and into the discharge duct 72 of the cleaning piston 66. The fluid contaminated with impurities/deposits is then discharged in a known manner via the discharge duct 72.

The receiving recesses 68, 70 of the cleaning piston 66 extend over a part of the inlet openings 36a of the filter support walls 30, 32. The total area of the sum of the areas of input openings 36a or the partial areas of the input openings 36a covered by the receiving recesses 68, 70 results in a predetermined total area with the value F₁. The value F₁ always remains the same over the travel path of the cleaning piston 66 both in the starting position and the end position, although the rows of input openings 36a and thus the partial areas of the input openings 36a change continuously as the cleaning piston 66 moves.

The receiving recess 68, 70 is at least as large in the direction of travel as the diameter D of the through-holes 36 of the filter support walls 30, 32. A row of inlet openings 36a can be arranged in such a way that, in a travel position of the cleaning piston 66, the first edge of the receiving recesses 68, 70 of the cleaning piston 66 is aligned with the edge of the inlet openings 36a of a row and these openings are located completely within the receiving recesses 68, 70. The second edge of the receiving recesses 68, 70 may be aligned with the edge of the inlet openings 36a of an adjacent row. Their inlet openings 36a are not located within the receiving recesses 68, 70 at this point.

The recesses 68, 70 are each formed in the same way. The receiving recesses 68, 70 can each be designed as a groove with channels to the discharge duct 72 or they can extend radially inwards to the discharge duct 72 in the manner of a cylindrical segment.

Furthermore, a mounting ring 74 is slidably arranged on the piston 14. The mounting ring 74 is equipped with four handles 74a, 74b, 74c, 74d which can be used to move the mounting ring 74 on the piston 14. The piston 14 has a length that is dimensioned such that the piston 14 protrudes from the housing 12 in the filter position, namely more than the amount of the width of the mounting ring 74 and the end stop 60. In the filter position, the mounting ring 74 is arranged between the seal 56 and the end stop 60.

The individual filter support walls 30, 32, the filter screen 38, 40, the stop walls 42, 44 are each of the same design.

The mounting ring 74 is aligned in such a way that its first stop surface 74e pointing towards the housing 12 and the second stop surface 74f pointing towards the end stop 60 are aligned plane-parallel relative to one another. Analogously, the surface of the housing 12 associated with the mounting ring 74 and a surface of the end stop 60 associated with the mounting ring 74 are formed parallel to this.

If the filter screens 38, 40 are to be changed, the piston 14 moves from the filter position into the screen-changing position. The stop walls 42, 44 are then removed by making an appropriate tool engage in the groove 54b and lifting the stop walls 42, 44 and removing them from the piston 14. The tool is then inserted into the groove 54b, the filter screens 38, 40 are lifted and removed from the piston 14. The filter screens 38, 40 are replaced, i.e. new filter screens 38, 40 are reinserted into the piston 14. The stop walls 42, 44 are then reinserted into piston 14 until the side walls 42a, 44a are aligned with the outer circumference of piston 14. For ease of inspection and to ensure that the stop walls 42, 44 do not come loose and protrude beyond the outer circumference of the piston 14, the mounting ring 74 is gripped via at least one of the handles 74a, 74b, 74c, 74d and pushed over the stop walls 42, 44. The mounting ring 74 then remains in this position. Next, the piston 14 moves from the screen-changing position into the filter position. In doing so, the mounting ring 74 moves with its first stop surface 74e against the associated surface of the housing 12. If necessary, the piston 14 is moved to the extent that the end stop 60 has its surface associated with the dismounting ring 74 resting against the second stop surface 74f. This ensures that the stop walls 42, 44 do not protrude beyond the outer circumferential surface of the piston during the entire travel of the piston 14. The filter assembly 10 is now ready again for filtering more fluid.

The invention is characterized by the fact that filtered fluid is constantly backwashed within the filter assembly 10, thus avoiding pressure fluctuations due to the backwashing. The amount of backwashed fluid in the filter assembly 10 always remains the same. The cleaning piston 66 is constantly moved back and forth from the starting position to the second end position. The cleaning piston 66 can be moved at a speed which is in a range of between 10% and 200% of the discharge speed of the filtered fluid/the input speed of the fluid to be filtered, in particular in a range of between 45% and 150%.

Preferably, the amount of backwashed fluid is in a range of between 0.1% and 2% of the fluid introduced into the filter assembly 10, in particular in a range of between 0.5% and 1.0%.

FIG. 10 shows a variant of the embodiment according to the invention described with reference to FIGS. 1 to 9, namely a longitudinal sectional view of the filter assembly 10. The filter assembly 10 has a two-part filter support wall 76. The filter support wall 76 comprises an inner sleeve 78 and a basic filter support wall 80 which receives and holds the inner sleeve. The inner sleeve 78 is detachably connected to the basic filter support wall 80. The inner sleeve 78 is centered along the longitudinal axis 34 when it is inserted at the front and rear ends of the inner chamber 26. Otherwise, the filter assembly 10 shown in FIG. 10 is constructed in exactly the same way as explained with reference to the previous Figures. Therefore, the same reference signs are used here to denote the same parts.

FIGS. 11 and 12 show a further variant of the embodiment according to the invention. As seen in these Figures, the through-holes 36, the inlet openings 36a and the outlet openings 36b are slot-shaped in a radial direction relative to the longitudinal axis 34. The height is multiple times greater than the width. The cross-sectional area of the through-holes 36 correspond to 75% of the cross-sectional area of the receiving recess 68, 70 of the cleaning piston 66. The shape of the through-holes 36 corresponds to the shape of the receiving recess 68, 70 of the cleaning piston 66. The through-holes 36 are made in the detachable inner sleeve 78. The slot-shaped design of the through-holes 36 is a simple way of increasing the actual filter surface area.

The present embodiments shows an extendable piston 14 having a flow body 14c, filter support walls 30, 32, 76, filter screens 38, 40, and stop walls 42, 44. However, several such extendable pistons 14 are also conceivable.

### LIST OF REFERENCE SIGNS

10 filter assembly with piston screen changer
12 housing
14 piston
14a receiving area—left
14b receiving area—right
14c flow body
16 inlet opening
18 threaded hole
20 discharge opening
22 threaded hole
24 feed line
26 interior
28 inner walls of piston 14
30 filter support wall—left
32 filter support wall—right
34 longitudinal axis of piston 14
36 through-hole of filter support wall 30, 32
36a inlet opening
36b exit opening
38 filter screen—left
40 filter screen—right
42 stop wall—left
42a side wall of stop wall 42—left
42b U-shaped recess in side wall 42a—left
44 stop wall—right
44a side wall of stop wall 44—right
44b U-shaped recess in side wall 44a—right
46 through-hole of stop wall 42, 44
48 outlet chamber—left
50 outlet chamber—right
52 discharge line
54 plate for one side of the receiving area 14a, 14b of piston 14
54a screw for fastening plate 54
54b groove in plate 54 for easier release of stop wall 42, 44
56 seal
58 additional seal
60 end stop
62 threaded hole on front of piston 14
64 piston rod for cleaning piston 66
66 cleaning piston
68 receiving recess—left
70 receiving recess—right
72 discharge duct
74 mounting ring
74a handle—left
74b handle—bottom
74c handle—right
74d handle—top
74e first bearing surface—associated with housing 12
74f second bearing surface—associated with end stop 60
76 filter support wall
78 inner sleeve
80 basic filter support wall

1-33. (canceled)

34. Filter assembly (10) for a fluid to be filtered, having a filter housing (12), wherein a flow body (14c), a filter screen (38, 40) and a stop wall (42, 44) for the filter screen (38, 40) are provided in the filter housing (12), which separate a first chamber (26) and a second chamber (48, 50) from one another,
the flow body (14c) has a filter support wall (30, 32) with a first side and a second side remote from the first side, the second side of which rests against the filter screen (38, 40) at least in certain regions and holds the filter screen (38, 40) against the stop wall (42, 44),
the first chamber (26) is connected to an inlet duct (24) and the second chamber (48, 50) is connected to an outlet duct (52),
made in the filter support wall (30, 32) are through-channels (36) with associated openings (36a, 36b) which are provided on each side of the filter support wall (30, 32), through which the fluid is made to flow out of the first chamber (26) via the first opening (36a) through the through-channel (36) to the second opening (36b) for filtering to the filter screen (38, 40),
through-channels (46) with openings on each side of the stop wall are provided in the stop wall, through which the filtered fluid is made to flow from the filter screen (38, 40) into the second chamber,
a displaceable cleaning piston (66) is provided, which
rests against the first side of the filter support wall (30, 32) with a guide area thereof,
has at least one receiving recess (68, 70) within the guide area, into which part of the first openings (36a) of the filter support wall (30, 32) extend,
is provided with a discharge duct (72) connected to the receiving recess (68, 70) for discharging the backwashed fluid, so that moving the cleaning piston (66) along the filter support wall (30, 32) removes deposits on the stop wall (42, 44), on the filter screen (38, 40) and on the filter support wall (30, 32) by backwashing some of the filtered fluid from the second chamber (48, 50) through the stop wall the filter screen (38, 40), the filter support wall (30, 32), the receiving recess (68, 70) of the cleaning piston (66), into the discharge duct (72) of the cleaning piston (66),
characterized in that the first openings (36a) of the through-channels (36) of the filter support wall (30, 32) and the dimensions of the cleaning piston (66) are matched to one another in such a way that the total surface area of the first openings (36a) and regions of first openings (36a) extending into the receiving recess (68, 70) adds up to a value F1, said value F1 always being the same over a travel path of the cleaning piston (66) across the region of the first openings (36a) of the through-channels (36) of the filter support wall (30, 32).

35. Filter assembly according to claim 34, characterized in that the cleaning piston (66) has a first and a second end position, that the travel path of the cleaning piston (66) extends between the first and the second end position, and that the value F1 always remains the same both in the two end positions and over the entire piston travel path.

36. Filter assembly according to claim 34, characterized in that the travel path of the cleaning piston (66) is linear.

37. Filter assembly according to claim 36, characterized in that plural rows of first openings (36a) of the filter support wall (30, 32) are provided in the direction of the travel path, starting from an end position of the cleaning piston (66), with the centers of a row of first openings (36a) lying in a plane perpendicular to the travel path, with the cross-sectional area of a row having the value F2, where F2=K×F2, with K>0.

38. Filter assembly according to claim 37, characterized in that adjacent rows of first openings (36a) are arranged offset with respect to one another, in particular perpendicular to an axis of the cleaning piston (66).

39. Filter assembly according to claim 37, characterized in that the value F2 of the sum of the cross-sectional areas of a row of first openings corresponds to the value F1.

40. Filter assembly according to claim 34, characterized in that at least the cross-sectional area of each first opening (36a) and the cross-sectional area of the through-channel (36) adjoining it are each of the same shape, in particular also their outer circumferential shape, preferably each first opening (36a) and the through-channel (36) adjoining it have a circular cross-section with a diameter D and a radius R, particularly preferably each first opening (36a) and the through-channel (36) adjoining it have a hexagonal cross-section.

41. Filter assembly according to claim 39, characterized in that the distance of the receiving recess (68, 70) of the cleaning piston (66) in a direction of travel of the cleaning piston (66) is such that it is equal to or greater than the diameter D of the first opening.

42. Filter assembly according to claim 41, characterized in that the rows of first openings are arranged in such a way that, in a travel position of the cleaning piston (66) and with K=1 and thus F1=F2, the first edge of the receiving recess (68, 70) of the cleaning piston (66) is flush with the edge of first openings (36a) of a row, and these openings are completely located within the receiving recess, and the second edge of the receiving recess (68, 70) is flush with the edge of first openings (36a) of an adjacent row, the openings (36a) of which are not currently located within the receiving recess (68, 70).

43. Filter assembly according to claim 34, characterized in that it is integrated into a plant for profile film or sheet production or granulation.

44. Filter assembly according to claim 34, characterized in that the cleaning piston (66) is cylindrical, the filter support wall (30, 32) is adapted to the cleaning piston (66), and the filter screen (38, 40) and the stop wall (42, are adapted to the shape of the filter support wall (30, 32).

45. Filter assembly according to claim 44, characterized in that the filter support wall (30, 32), the filter screen (38, 40) and the stop wall extend in the circumferential direction over a partial circumference of the cleaning piston (66).

46. Filter assembly according to claim 45, characterized in that the receiving recess (68, 70) of the cleaning piston (66) comprises at least this partial circumference, in particular the receiving recess (68, 70) extends at least over this partial circumference in the circumferential direction.

47. Filter assembly according to claim 46, characterized in that the receiving recess (68, 70) is either designed as a groove with channels to the discharge duct (72) or it extends radially inwards to the discharge duct (72) in the manner of a cylindrical segment.

48. Filter assembly according to claim 44, characterized in that the filter screen (38, 40) and the stop wall (42, 44) are designed in two parts, in particular they are designed as two identical components in each case.

49. Filter assembly according to claim 48, characterized in that the filter support wall (30, 32) also has at least two areas assigned to the filter screen and the filter support wall, in which the through-channels (36) with the openings (36a, 36b) are provided.

50. Filter assembly according to claim 49, characterized in that at least two receiving recesses (68, 70) are provided in the cleaning piston (66), which are assigned to the regions with the first openings (36a) and through-channels (36) of the filter support wall (30, 32).

51. Filter assembly according to claim 48, characterized in that each part of the stop wall (42, 44) is designed as a cylindrical segment which extends only over a partial angle in the circumferential direction and includes outer walls (42a, that extend radially outwards away from the filter screen (38, 40) and laterally surround the region with the openings (36b).

52. Filter assembly according to claim 51, characterized in that the flow body (14c) encloses the outer walls (42a, at least in some areas, in particular completely, right up to the outward-facing end faces.

53. Filter assembly according to claim 34, characterized in that the flow body (14c) with the filter screen (38, 40) and the stop wall (42, 44) as well as the cleaning piston (66) arranged inside the flow body (14c) is part of a piston (14) which can be extended to out of the filter housing (12) for changing the filter screens (38, 40), with the individual components of the stop wall (42, 44) and the individual components of the filter screen (38, 40) being detachably arranged in the flow body (14c).

54. Filter assembly according to claim 53, characterized in that it has installed in it at least two extendable pistons (14) with filter screens (38, 40) and stop walls as well as the cleaning piston (66) arranged inside the flow bodies (14c).

55. Filter assembly according to claim 34, characterized in that the through-channels (36) of the filter support wall (30, 32) extend radially with respect to a concentric axis of the cleaning piston (66), in particular these through-channels (sixth 30) of the filter support wall (30, 32) are aligned with associated through-channels (46) of the stop wall (42, 44).

56. Method for filtering fluid using a filter assembly, in particular according to claim 34, characterized in that filtered fluid is permanently backwashed within the filter assembly (10).

57. Method according to claim 56, characterized in that the quantity of fluid backwashed within the filter assembly (10) remains the same.

58. Method according to claim 56, characterized in that the fluids filtered are of a low viscosity, preferably of a range of between 50 Pas and 5,000 Pas.

59. Method according to claims 56, characterized in that the cleaning piston (66) is constantly moved back and forth from the first end position to the second end position.

60. Method according to claim 56, characterized in that the cleaning piston (66) is moved at a speed which is in a range of between 10% and 200% of the discharge speed of the filtered fluid/the input speed of the fluid to be filtered, in particular in a range of between 45% and 150%.

61. Method according to claim 56, characterized in that the amount of backwashed fluid is in a range of between 0.1% and 2.0% of the fluid introduced into the filter assembly (10), in particular in a range of between 0.5% and 1.0%.

62. Filter assembly according to claim 34, characterized in that the filter support wall (76) is provided with an inner sleeve (78) and a basic filter support wall (80), with the inner sleeve (78) comprising the first and second openings (36a, 36b) and the through-channels (36).

63. Filter assembly according to claim 62, characterized in that the inner sleeve (78) is detachably connected to the basic filter support wall (80).

64. Filter assembly according to claim 34, characterized in that the cross-sectional areas of the openings (36a, 36b) and of the through-channels (36) each have a height and a width, with the height being several times greater than the width.

65. Filter assembly according to claim 34, characterized in that the cross-sectional area of the openings (36a, 36b) corresponds to 75% of the cross-sectional area of the receiving recesses (68, 70).

66. Filter assembly according to claim 65, characterized in that the cross-sectional shape of each opening (36a, 36b) corresponds to the cross-sectional shape of the associated receiving recess (68, 70).
